(19) United States
(12) Patent Application Publication
(10) Pub. No.: US 2011/0205121 A1
(43) Pub. Date: Aug. 25, 2011

(54) METHOD OF DETERMINING REAL TIME LOCATION OF REFLECTING OBJECTS AND SYSTEM THEREOF

(75) Inventors: Eyal HOCHDORF, Falls Church, VA (US); Nimrod SHANI, Herzliya (IL); Ran TIMAR, Givaataim (IL)

(73) Assignee: CAMERO-TECH LTD., Netanya (IL)

(21) Appl. No.: 13/042,072

(22) Filed: Mar. 7, 2011

Related U.S. Application Data
(63) Continuation-in-part of application No. 12/164,752, filed on Jun. 30, 2008, now Pat. No. 7,925,251.
Application No. 12/164,752 is a continuation of application No. PCT/IL2006/001502, filed on Dec. 28, 2006.

(30) Foreign Application Priority Data
Dec. 28, 2005 (IL) 172864

(51) Int. Cl. H01Q 3/22

(52) U.S. Cl. 342/375; 342/377

(57) ABSTRACT

There are provided a method of determining real time location of a reflecting object and a system thereof. The method comprises: a) providing initial internal delays of said RF units, and providing initial direct signal time of arrivals characterizing direct links between RF units corresponding to said operational links; b) transmitting operational signals, and measuring real time of arrivals characterizing operational links; c) transmitting direct signals via direct links corresponding to said operational links, and measuring real time direct signal time of arrivals characterizing said direct links; d) calculating, separately for each of the operational links, cumulative real time internal delays in RF units, said calculating based on measured real time direct signal time of arrival in corresponding direct link, respective initial direct signal time of arrival and initial internal delays of respective RF units; e) calculating relative delays between the operational links and aligning the respective links; and f) determining the real time location of the object, wherein operational signal and corresponding direct signal are constituted by different lobe components of a same signal transmitted between respective RF units.

### CROSS-REFERENCES TO RELATED APPLICATIONS

This application relates to and claims priority from U.S. patent application No. 12/164,752 filed on Jun. 30, 2008 claiming priority from International Application No. WO2007/074460 filed on Dec. 28, 2006 and claiming priority from Israeli Patent Application No. IL 172864 filed on Dec. 28, 2005, all applications incorporated herein by reference in their entirety.

### FIELD OF THE INVENTION

The invention relates, in general, to methods and systems for determining real time location of reflecting objects, and, in particular, to estimation of internal delays in respective receivers and transmitters.

### BACKGROUND OF THE INVENTION

One of the main tasks of a radar system is to be able to determine the location of a reflecting object relative to the radar's origin. The measured delay between the initiation of a transmit signal and the acceptance of the received signal contains, besides the travel time of the signal from the transmitter to the reflecting object and back to the receiver, also an internal delay of both the transmitter and receiver.

The problems of estimation of internal delays in transmitters and receivers have been recognized in the Prior Art and various systems have been developed to provide a solution, for example:

US Patent Application No. 2008/261536 discloses a method and a system for determining changes in internal delays of RF units, the RF units including a plurality of receivers and transmitters. The method includes providing initial direct signals' time of arrivals of the RF units initial internal delays of the RF units. Following this, each transmitter transmitting a direct signal, and the real time direct signal's time of arrivals of the RF units, are measured. Then, changes in internal delays of the RF units are calculated based on the real time direct signals' time of arrivals and initial direct signals' time of arrivals. And finally, real time internal delays of the RF units are calculated based on the changes in internal delays and the initial internal delays of the RF units.

U.S. Pat. No. 5,160,933 discloses a radar altimeter incorporating circuitry for automatically adjusting altitude readings for variations caused by altitude and temperature changes. Normal target tracking of the radar is intermittently interrupted and a calibration sequence is interjected. The current altitude and receiver AGC information at the time of each interruption is temporarily stored and a test is initiated in which a pseudo radar return at that altitude is introduced to the receiver. The receiver operates on the pseudo return as it would on an actual return. The transmit power is adjusted automatically for the correct signal level at the tracker. The resultant altitude measured for the pseudo return is compared to a known test altitude and any difference is stored away as a correction factor to be applied to the altitude reading which had been stored at the time that its operation had been interrupted to perform the calibration test.

U.S. Pat. No. 7,075,478 discloses a radar altimeter for an air vehicle. The radar altimeter includes a transmit antenna configured to transmit radar signals toward the ground, a receive antenna configured to receive radar signals reflected from the ground, the receive antenna also receiving signals propagated along a leakage path from the transmit antenna, and a receiver configured to receive signals from the receive antenna. The radar altimeter also includes at least one altitude processing channel configured to receive signals from the receiver to determine an altitude, and an automatic sensitivity-range-control (SRC) channel configured to receive signals from the receiver. The SRC channel is configured to determine an amplitude of the received leakage path signals when an altitude of the radar altimeter is sufficient to separate received signals reflected from the ground from signals received from the leakage path.

### SUMMARY OF THE INVENTION

In accordance with certain aspects of the presently disclosed subject matter, there is provided a method of determining real time location of a reflecting object with the help of a plurality of operational signals, the method to be used in an association with a system comprising a plurality of RF units, said plurality comprising at least two transmitter and at least two receivers. Each operational signal transmitted by a certain transmitter towards the object and received by a corresponding receiver upon reflecting from the object, to yield a plurality of operational links between respective RF units. The method comprises: a) providing initial internal delays of said RF units, and providing initial direct signal time of arrivals characterizing direct links between RF units corresponding to said operational links; b) transmitting operational signals, and measuring real time of arrivals characterizing operational links; c) transmitting direct signals via direct links corresponding to said operational links, and measuring real time direct signal time of arrivals characterizing said direct links; d) calculating, separately for each of the operational links, cumulative real time internal delays in RF units, said calculating based on measured real time direct signal time of arrival in corresponding direct link, respective initial direct signal time of arrival and initial internal delays of respective RF units; e) calculating relative delays between the operational links and aligning the respective links; and f) determining the real time location of the object, wherein operational signal and corresponding direct signal are constituted by different lobe components of a same signal transmitted between respective RF units.

In accordance with further aspects, the real time location of the reflection object can be determined with the help of operational signals measured for at least two co-polar operation links with different polarization and at least one cross-polar operational link, thereby enabling determining three-dimensional location of said object. The co-polar operational links can comprise at least one link between a horizontally polarized transmitter and a horizontally polarized receiver and at least one link between a vertically polarized transmitter and a vertically polarized receiver, and cross-polar operational links can comprise at least one link between the vertically polarized transmitter and the horizontally polarized receiver or between the horizontally polarized transmitter and the vertically polarized receiver.

The initial internal delays of said RF units can comprise initial internal delays of receivers operable in co-polar links and initial internal delays of the same receivers operable in cross-polar links.

In accordance with further aspects, at least part of RF units can be located in a substantial proximity from an obstacle. Accordingly, the method further comprises measuring obstacle-influenced time of arrivals in the corresponding direct links, and calculating said cumulative real time internal delays in RF units based on the measured obstacle-influenced time of arrivals in direct links instead of initial direct signal time of arrival in the respective direct links.

In accordance with certain aspects of the presently disclosed subject matter, there is provided an RF system comprising a plurality of RF units and a computer system with a data storage unit operatively coupled to the RF units, said plurality of RF units comprising at least two transmitters and at least two receivers. The system is operable to determine real time location of a reflecting object with the help of a plurality of operational signals, each operational signal transmitted by a certain transmitter towards the object and received by a corresponding receiver upon reflecting from the object, to yield a plurality of operational links between respective RF units, wherein the computer system is operable: to provide initial internal delays of said RF units; to provide initial and real time direct signal time of arrivals characterizing direct links between RF units corresponding to said operational links; to calculate, separately for each of the operational links, cumulative real time internal delays in RF units, said calculating based on measured real time direct signal time of arrival in corresponding direct link, respective initial direct signal time of arrival and initial internal delays of respective RF units; and to calculate relative delays between the operational links and aligning the respective links; thereby to enable determining the real time location of the object, wherein operational signal and corresponding direct signal are constituted by different lobe components of a same signal transmitted between respective RF units.

The plurality of RF units can comprise at least two transmitters with different polarization and at least two receivers with different polarization, wherein the real time location of the reflection object can be determined with the help of operational signals measured for at least two co-polar operation links with different polarization and at least one cross-polar operational link, thereby enabling determining three-dimensional location of said object.

The co-polar operational links can comprise at least one link between the horizontally polarized transmitter and the horizontally polarized receiver and at least one link between the vertically polarized transmitter and the vertically polarized receiver, and cross-polar operational links comprise at least one link between the vertically polarized transmitter and the horizontally polarized receiver or between the horizontally polarized transmitter and the vertically polarized receiver.

Among advantages of certain embodiments of the currently presented subject matter is self calibration of the system capable of determining three-dimensional location of the object, such calibration provided during regular operation of the system with no need in dedicated hardware, dedicated time or a dedicated unique transmit signal during the operation.

Among further advantages of certain embodiments of the currently presented subject matter is capability of aligning a plurality of multi-polar operational links, thereby enabling three-dimensional imaging.

Among further advantages of certain embodiments of the currently presented subject matter is capability of correcting calibration for through obstacle applications.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 schematically illustrates a generalized functional block diagram of an exemplary system where the presently disclosed subject matter can be implemented;

FIG. 2 illustrates a generalized flow chart of operating the system in accordance with certain embodiments of the currently presented subject matter;

FIG. 3 illustrates a schematic example of the system in accordance with certain embodiments of the currently presented subject matter;

FIG. 4 illustrates a schematic example of a system that includes an array of transmitters and receivers used for determining initial internal delays, in accordance with certain embodiments of the currently presented subject matter;

FIG. 5 illustrates a block diagram circuitry for calculating time of arrival, in accordance with certain embodiments of the currently presented subject matter;

FIGS. 6A-B illustrate schematically two signal waveforms sampled at selected points in the circuitry of FIG. 5; and

FIG. 7 illustrates a generalized flow-chart of calibrating the system in a case of obstacle-influences internal delays, in accordance with certain embodiments of the currently presented subject matter.

### DETAILED DESCRIPTION OF EXEMPLARY EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating” or the like, refer to the action and/or processes of a computer that manipulate and/or transform data into other data, said data represented as physical, such as electronic, quantities and/or said data representing the physical objects. The term “computer” should be expansively construed to cover any kind of electronic system with data processing capabilities.

The operations in accordance with the teachings herein may be performed by a computer specially constructed for the desired purposes or by a general-purpose computer specially configured for the desired purpose by a computer program stored in a computer readable storage medium.

Embodiments of the present invention are not described with reference to any particular programming language. It will be appreciated that a variety of programming languages may be used to implement the teachings of the inventions as described herein.

Note also that terms transmitter and Tx are used interchangeably. Note also that the terms receiver and Rx are used interchangeably. Transmitter, receiver and transceiver are each referred to also as Radio Frequency (RF) unit.

Note that a channel (link) having the same polarity of respective RF units is referred to hereinafter as co-channel (or co-polar link) to and a channel (link) having cross-polarity of respective RF units is referred to hereinafter as a cross-channel (cross-polar link). For the purpose of illustration only, the linear polarizations are used when co-polar means vertical to vertical or horizontal to horizontal transmit to receive channels and cross-polar means vertical to horizontal or horizontal to vertical channel. Those versed in the art will readily appreciate that the presently disclosed subject matter is not bound by linear polarization embodiments.

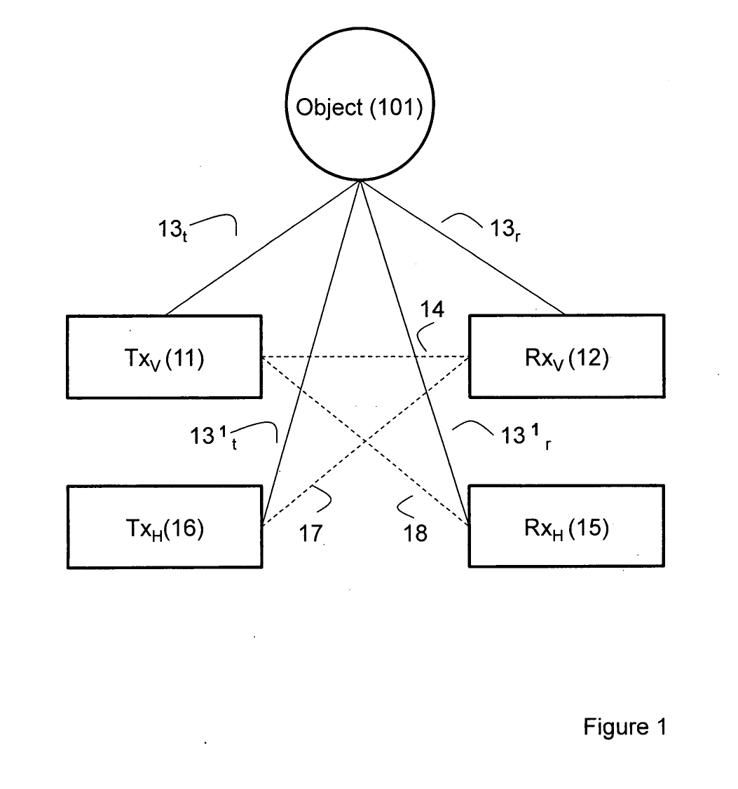

Bearing this in mind, attention is drawn to FIG. 1, illustrating a generalized block diagram of an exemplary system where the presently disclosed subject matter can be implemented.

The illustrated system (e.g. a radar system) is operative to determine in real time the location of an object (10). FIG. 1 illustrates, for simplicity, four RF units, a transmitter (11) in vertical polarization, a transmitter (16) in horizontal polarization, a receiver (12) in vertical polarization and a receiver (15) in horizontal polarization. A signal is transmitted from the transmitter (11), travels to the object (10) and is therefrom reflected towards the receivers (12) and (15). Accordingly, the signal between the transmitter 11 and receivers 12 and/or 15 travels, respectively, through operational links (13ₜ+13ᵣ) and (13ₜ+13¹ᵣ). A signal which travels via an operational link is referred to hereinafter as an operational signal. Likewise, the operational signal between the transmitter 16, the object, and receivers 12 and/or 15 travels, respectively, through operational links (13¹ₖ+13ᵣ) and (13¹ₜ+13¹ᵣ.

Cross polarity of the channels can bear additional information and, thus, calculating internal delays for dual-polarity systems requires special attention. A non-limiting example of dual-polarity systems is an ultra-wide-band three-dimensional imaging system. In such a system, in order to determine a three-dimensional location of an object, all three separate sets of inputs received via three types of operational links (i.e. Vertical to Vertical, Horizontal to Horizontal and Vertical to Horizontal (or Horizontal to Vertical)) need to be aligned. In order to provide a superior image, a coherency of respective operational links with millimeter level accuracy is required. Placing the device on a wall or other obstacle can alter the antenna properties and, accordingly, requires further precise calculating of internal delays and enabling aligning of dual-polarity channels.

The object's location can be determined according to the travel time of the signal, such that the longer the travel time, the more distant is the object relative to the Tx/Rx system. The total travel time of the operational signal D_{measured} along an operational link is not only dependent on the actual travel time of the signal in the space Dₛₚ, but also on the time delay of the signal at a respective transmitter (D_{Tx}) and the time delay of the signal at a respective receiver (D_{Rx}). The sought Dₛₚ complies, thus, with the following equation:

Dₛₚ=D_{measured}−(D_{Tx}+D_{Rx}). (1)

The internal time delays vary over time and therefore initial internal delays D_{Tx} and D_{Rx} that are provided by the manufacturer (or, say, calculated at a given timing) are likely to vary when the system is actually used (at a later stage) for determining the real time location of the object 10. It is therefore required to determine the real time internal delays D_{Tx}′ and D_{Rx}′ of the transmitters and receivers. Thus when it is actually required to determine the object location (in real time), Dₛₚ′ will comply with the equation:

Dₛₚ′=D_{measured}′−D_{Tx}′−D_{Rx}′ (2)

wherein the superscript denoted as ′ signifies that all the delays were calculated in real time.

Note, that in accordance with certain embodiments of currently presented subject matter, there is no need to determine variations of internal delays of separate RF units (say, D_{Tx} for the transmitter 11 and D_{Rx} for the receiver 12), the internal delays of the RF units can be provided per link, e.g. the cumulative internal delays (D_{Tx}+D_{Rx}) of the transmitter 11 and receiver 12 for operational link (13ₜ+13ᵣ) (likewise, cumulative internal delays of the transmitter 16 and receiver 15 for operational link (13¹₁+13¹ᵣ, cumulative internal delays of the transmitter 11 and receiver 15 for operational link (13ₜ+13¹ᵣ), or cumulative internal delays of the transmitter 16 and receiver 12 for operational link (13¹₁+13ᵣ)).

Given the dual polarization of the RF units, there is a requirement to provide respective sets of initial delay values. Each transmitter transmits the same signal hence it should have the same internal delay for either co-polar? and cross-polar channel regardless of the associated receiver. Each receiver is characterized by the delay associated with a co-polar link reception and a delay associated with the cross-polar link reception.

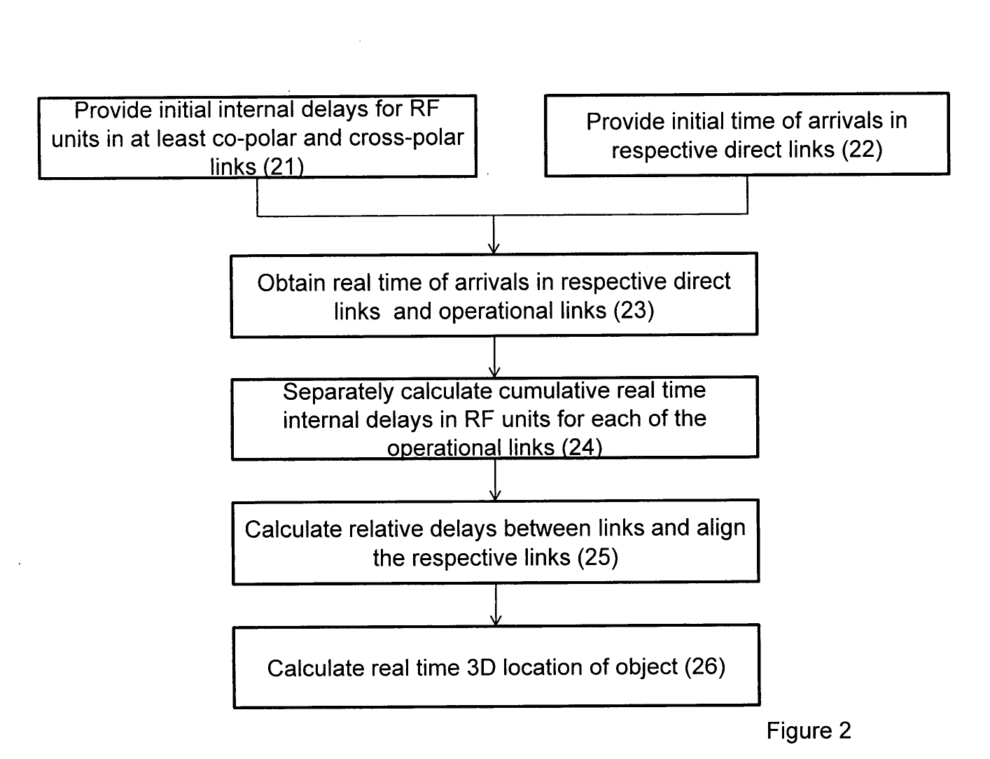

As will be further detailed with reference to FIG. 2, characteristics of the direct links between transmitters and receivers can be used for calculating the real time internal delays of respective RF units. A signal travelling between a transmitter and a receiver via a direct channel is referred to hereinafter as a direct signal.

At the initial stage a direct signal is transmitted from the transmitter 11 to the receiver 12 through the direct link 14 in order to detect the initial time of arrival of the signal along the direct link 14. Likewise, the initial time of arrivals of the direct signal along the direct link is detected for direct cross polarization links (17) and (18). Initial time of arrivals in direct channels is measured during calibrating the system before operating.

An operational signal and a direct signal can be constituted by different lobe components of the same signal. Time of arrival in a certain link is measured for the respective lobe component (main lobe component or side lobe components) transmitted via a respective link.

Time of arrival signifies the duration/timing of travel of the signal from the transmitter to the receiver.

Later, when the real time location of the object needs to be determined using the operational links (e.g. between transmitters 11 and/or 16 and receivers 12 and/or 15), another session takes place wherein the real time of arrivals along the direct links is further detected. As will be noted from the description below, the change of time of arrivals (between the initial and real time terms) signifies the change of internal delays of the transmitters/receivers. Now based on the initial internal delays (e.g. D_{Tx}, D_{RX}) and the specified calculated change in time delays, the real time D_{Tx}′ and D_{Rx}′ internal delays can be determined and used for obtaining the Dₛₚ′ (e.g. in compliance with equation (2) above), and therefrom the object location, all as will be explained in greater detail below.

Note that measuring a signal in a direct channel does not require a significant side lobe component. By way of non-limiting example, the signal can have a substantial main lobe component (directed towards the object 10) and lesser significant side lobe components (directed to links 14, 17 and 18), however, the intensity of the latter signal can be sufficient to be detected by the respective receivers.

Note also that the specified equations (1) and (2), are provided for convenience only, and are by no means binding.

Those versed in the art will readily appreciate that the presently disclosed subject matter is not bound by the system illustrated in FIG. 1. Likewise, it is applicable for any appropriate combination of a plurality of transmitters and receivers capable of determining a location of one or more objects. The objects can be stationary or moving and may or may not have direct Line of Sight (LOS) with the radar system. For instance, there may be scenarios in which there is an obstacle, a wall for instance, that interferes with the LOS from the radar system to the object/objects (referred to occasionally also as “through the wall vision”). Note also that in certain embodiments, (e.g. radar system with an antenna array and plurality of receive/transmit channels) the location of the object needs to be determined with a very high precision, for example, in the order of millimeters. As is generally known per se this may require using Ultra-wide-Band signals.

Referring now to FIG. 2, there is illustrated a general sequence of operations, in accordance with certain embodiments of the currently presented subject matter.

In order to determine a three-dimensional location of the object, there is a need to combine signals reflected by the object in three operational links: two co-polar links (e.g. vertical to vertical and horizontal to horizontal) and one cross-polar link (e.g. vertical to horizontal or horizontal to vertical).

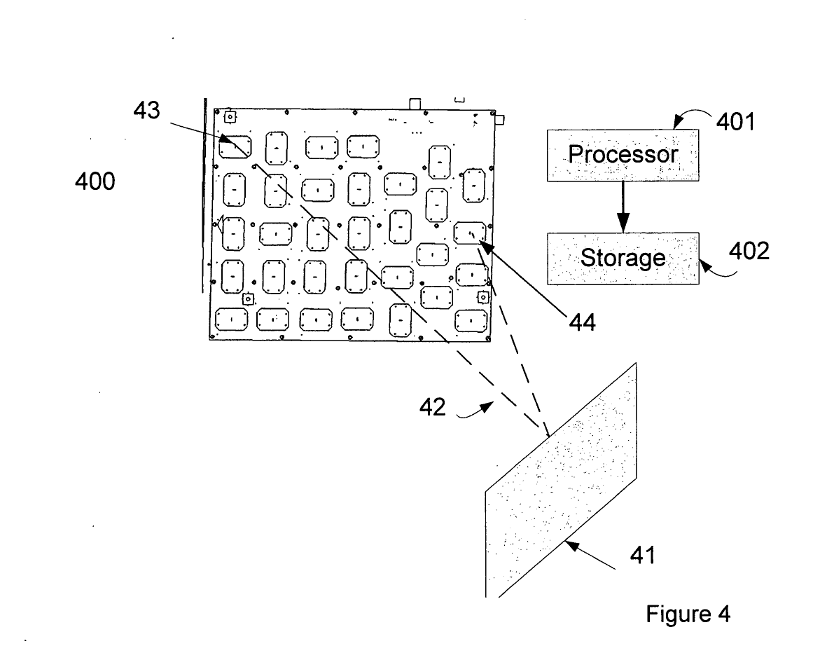

Initial internal delays of the transmitters and receivers in co-polar and cross-polar modes are provided (21) and stored for further use. By way of non-limiting example, the initial internal delays can be calculated in advance (e.g. in pre-defined laboratory conditions), as will be explained in detail with reference to FIG. 4 below; received from an external source (e.g. as manufacturing specification data of the transmitters/receivers), etc.

By way of non-limiting example, the internal delays of the transmitters and receivers may vary over time, for at least one of the following factors:
Temperature—Various types of transmitters and receivers contain electronic hardware whose timing response is sensitive to ambient temperature, especially for Ultra-Wide-Band applications requiring an accuracy of, say, picoseconds.
Supply Voltage—The same hardware is often sensitive to supply voltage as well, and as a result there could be timing offsets.

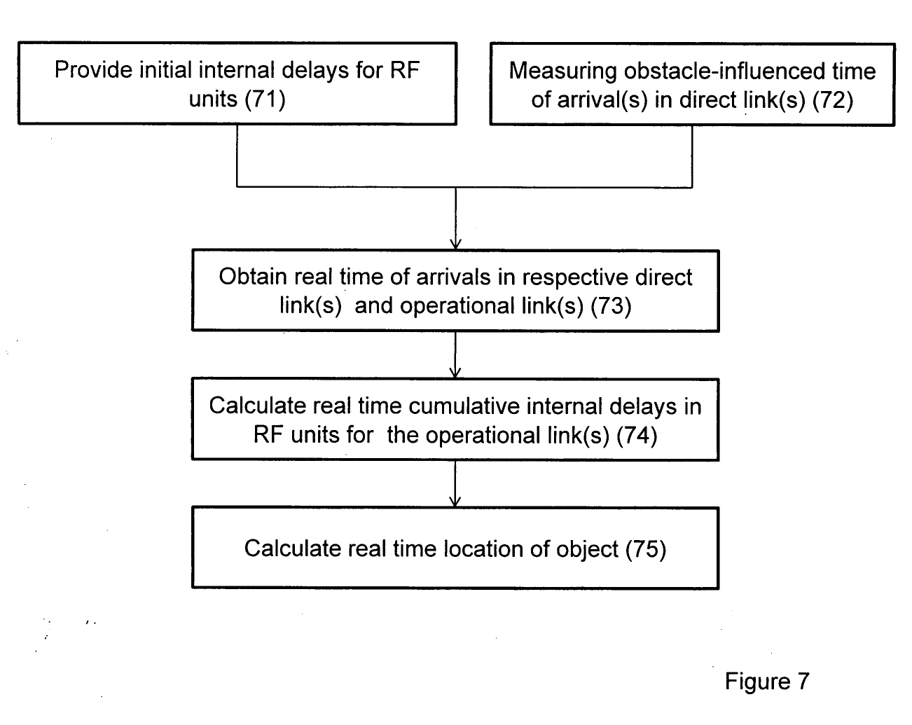

The internal delays can further vary because of an impact of obstacles. It should be further assumed that the system is stable on the obstacle, and the influence of the obstacle is constant and recaptured (e.g. as further detailed with reference to FIG. 7).

The method further includes providing (22) initial time of arrivals corresponding to the provided initial delays and characterizing direct co-polar and cross-polar links and storing the respective values for further use.

Real time of arrivals in the direct links and the operational links can be obtained (23) as follows:
the transmitters transmit signals towards the object and the receivers receive respective signals reflected from the object, thus giving rise to the operational signals transmitted via the operational links; and respective time of arrivals are measured,
a transmitters transmit direct signals to the receivers via corresponding direct co-polar and cross-polar links (i.e. links corresponding to the same transmitters and receivers as in respective operational links); and real time direct signal time of arrivals characterizing respective direct links are measured;

wherein each operational signal and respective co-polar and cross-polar direct signals are constituted by different lobe components of a same signal.

Cumulative real time internal delays are calculated (24) separately for each of the operational links (Vertical to Vertical, Horizontal to Horizontal Vertical to Horizontal (or Horizontal to Vertical), said calculations are provided based on real time of arrival in respected co-polar and cross-polar direct links and initial time of arrival and initial internal delays of RF units corresponding to each respective link. The operational signals from the respective operational links are aligned (25) in accordance with the further calculated relative real time internal delays, and a real time three-dimensional location of the object is further determined (26) based on the operational signals' time of arrivals and the real time relative internal delays of the operational links.

As specified above, the internal delays in the receivers/transmitters may adversely affect the resulting calculating of the object's location and, accordingly, these delays must be taken into account in particular when high precision measurement is required. As further stated above, the internal delays vary over time (due to, e.g. variable temperature conditions) and, accordingly, for real time determination of object location (in particular when high precision is required) the current (real time) internal delays should be calculated and taken into account in the determination of the real time object's location.

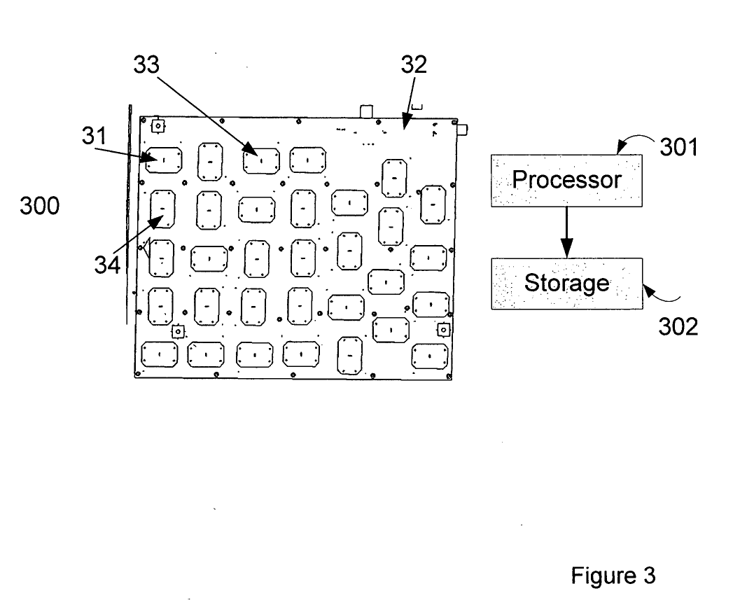

Bearing this in mind, attention is drawn to FIG. 3 illustrating schematically a system (30) that includes a plenary array of transmitters and receivers (300), in accordance with certain embodiments of the presently disclosed subject matter.

As shown, the array of transmitters and receivers is coupled to a processor unit (301) which in turn is coupled to a data storage unit (302), together constituting a computer system in accordance with an embodiment of the presently disclosed subject matter. Note that the geometric relations between the transmitters and the receivers in the array 300 are retained as invariable during the initial stage and in the later real time stage.

Those versed in the art will readily appreciate that the presently disclosed subject matter is not bound by plenary arrangement and accordingly other geometry arrangements are applicable as long as the geometric relation between the RF units in the array is retained substantially invariable in the initial (calibration) stage and at the later real time stage.

By this embodiment, a transmitter (31) is located at the outer part of the top-left section of the card 32 of the array 300, while a receiver is located in the inner part 33 which bears the same polarization and another receiver 34 close by bears orthogonal antenna properties. By this embodiment, both transmitter and receiver antennas have a directivity toward the front of the array (i.e. toward Z plane 35) and a signal transmitted in the direction of the antenna generates a signal in the Z axis 35 (the signal having substantial main lobe component, all as known per se. As is also known, there is still some remaining side gain (for instance pointed at substantially 90 degrees to the X-Y plane of the array). The latter gain is referred to as side-lobe component (constituting an example of direct signal). As specified above, in accordance with certain other embodiments, the transmitted signal may have a significant side lobe component compared to the main lobe component (if any). By this specific example, the array 300 includes a plurality of transmitters and a plurality of receivers. As is generally known per se, a single transmitter/receiver will be able to determine only range of a reflecting object and in one polarity only. In order to obtain three dimensional location data of the objects with both polarities as well as cross polarity information, more transmitters and receivers are required.

Those versed in the art will readily appreciate that the presently disclosed subject matter is not bound by the array architecture, the number of transmitters, and the number of receivers which are provided in FIG. 3 for illustrative purposes only. The presently disclosed subject matter is likewise not bound by any other design considerations, such as the specific architecture of the computer system (including processor and data storage unit) depicted in FIG. 3.

It should be further noted that the structure of transmitters and receivers used in a radar system is generally known per se and is not expounded upon herein. In accordance with certain embodiments, the transmitters/receivers have wideband pulses with higher transmit/receive resolution than the desired precision of the object's location.

Bearing all this in mind, there follows a description of the calculation of the initial internal delays (and initial time of arrivals) as well the real time internal delays (using also the real time of arrivals) in the multi transmitter/receiver embodiments.

Referring to FIG. 4, there is illustrated a non-limiting example of calculating (using array 400, processor 401 and data storage unit 402) initial internal delays for a plurality of transmitters and receivers. In order to calculate the initial delays (in the calibration stage) a reference object having a known simple (or relatively simple) characteristic is selected. By way of non-limiting example, a metal plate 41 serves as a reference reflecting object. It is noted that the presently disclosed subject matter is by no means bound by the use of a metal plate as a reference reflecting object. Also shown in FIG. 4 is an operational link 42 signifying a signal (hereinafter reflected signal) that is transmitted from transmitter 43 to the object 41 and reflected back towards receiver 44. Whilst not shown in FIG. 4, there is a plurality of possible operational links (all co-polar and cross-polar Tx-Rx combinations of all transmitters and receivers). The procedure described below for calculating the initial internal delays for the transmitters/receivers is performed at given and average conditions, such as temperature (e.g. 25° C.) and nominal supply voltage (e.g. batteries in fully charged state).

At the onset, the metal plate 41 is located at close distance to the array 400. The distance and orientation of this plate is unknown and is calculated during the calibration process. Note that in cases where the distance and orientation of the reference object (relative to the array) is known at the desired level or accuracy, the need to determine these data, is of course obviated.

Next, the transmitters are configured by the computer system to transmit a lobe signal from each transmitter which are reflected back from the plate 41 and received at the receivers. The computer system configures the receivers to receive the transmitted signals. Each signal is initiated from a specific transmitter, reflected from the plate 41 and received in a specific receiver, giving rise to a specific operational link (42) per receiver and transmitter and altogether different operational links (not shown in FIG. 4). Each of these reflected signals (traveling in a respective operational link) has a different path, and different timing. As will be shown below, for several transmitters and receivers it can be shown that there is enough information to calculate all the unknown parameters including the distance and orientation of the plate 31 as well as the initial internal delay of each transmitter and receiver.

For convenience, a single transmitter is chosen to have “zero” delay, thus all the other transmitters and receivers' timing will be calculated with respect to this transmitter. This assumption of “zero delay” facilitates to check system performance as well as to average results, however the zero delay is not obligatory.

For example, consider 256 channels (16 Rx and 16 Tx units), giving rise to 256 equations.

There are 31 unknown internal delay variables (the 32^{th} having zero delay), namely Tx2-Tx16 (altogether 16 transmitters) and Rx1-Rx16 (altogether 16 receivers). Additionally, the distance D and orientation (θ, φ angles) of the plate 41 are unknown (additional 3 variables), giving rise to a total of 34 unknown variables.

In accordance with certain embodiments, an iterative procedure is chosen to calculate these variables from the 256 channels equations:

By way of example, the iterative procedure is performed as follows:

A) Plate positioning—an orientation of the plate relative to the radar system is estimated. To this end, the three unknown variables are set to, say, arbitrary values.

B) Spatial Delay extraction—Given arbitrary selected orientation values of the plate, it is possible to calculate the spatial distance of an operational link (i.e. Tx->Plate->Rx) for each of the 256 channels. By way of example, this can be performed by using known per se geometrical equations. The plate and two points (TX and RX) are known, and a point on the plate which creates a triangle is searched such that the angle between this point to both TX and RX is equal. The search is performed iteratively and the result would be the sum of both triangle edges for the spatial distance.

C) Linear equation back substitution and averaging—relative to the measured delay, it is possible to obtain 256 equations of the following type:

D_{RX}+D_{TX}+Dₛₚ=D_{measured}

where D_{RX} is the sought receiver's initial internal delay, D_{TX} is the transmitter's initial internal delay, and Dₛₚ is the three-dimensional spatial delay of the Tx-Rx operational link (a summation of the distance between the transmitter and the object, and the distance between the object and the receiver).

It can be shown that the orientation of the plate has a single optimum position with respect to minimum measurement error, hence by iterative repositioning of the plate at an orientation and distance where the measurement to error tends to decrease, a minimum is reached, and eventually the delays are extracted as well as the distance and orientation of the plate.

The calculated during calibration stage (under predefined conditions) and stored (in storage 302) initial internal delays of the transmitters and the receivers (in co-polar and cross-polar modes) can be further used as detailed with reference to FIG. 2.

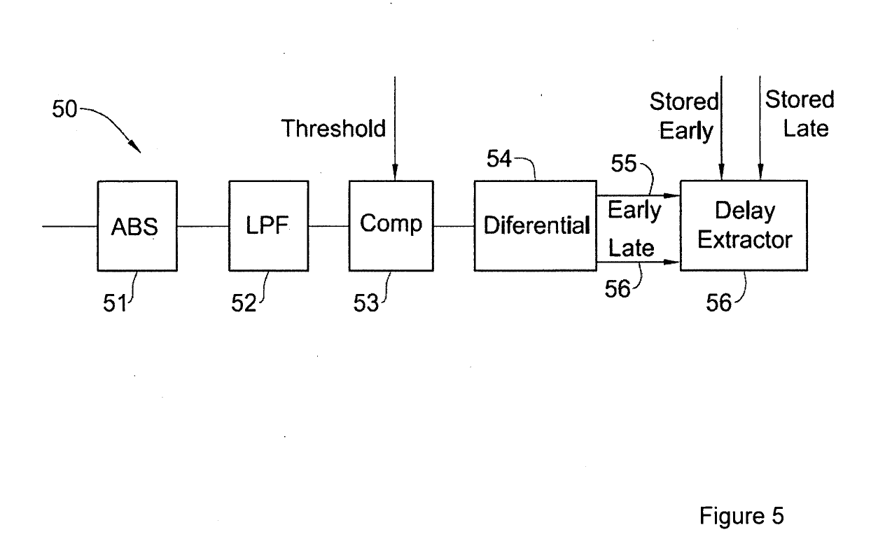

Referring to FIG. 5, there is illustrated a block diagram circuitry (50) for calculating time of arrival, in accordance with an embodiment of the presently disclosed subject matter.

Reverting to the example of FIG. 3, there can be 256 direct links and, accordingly, initial time of arrival of the direct signal in each direct link needs to be recorded (all with reference to given prevailing conditions, say 25° C. and batteries in fully charged state).

In accordance with certain embodiments, peak detection or envelope detection or other known per se techniques can be used. For purpose of illustration only, the following description is provided for an envelope detection operation followed by and Early-Late Estimation block.

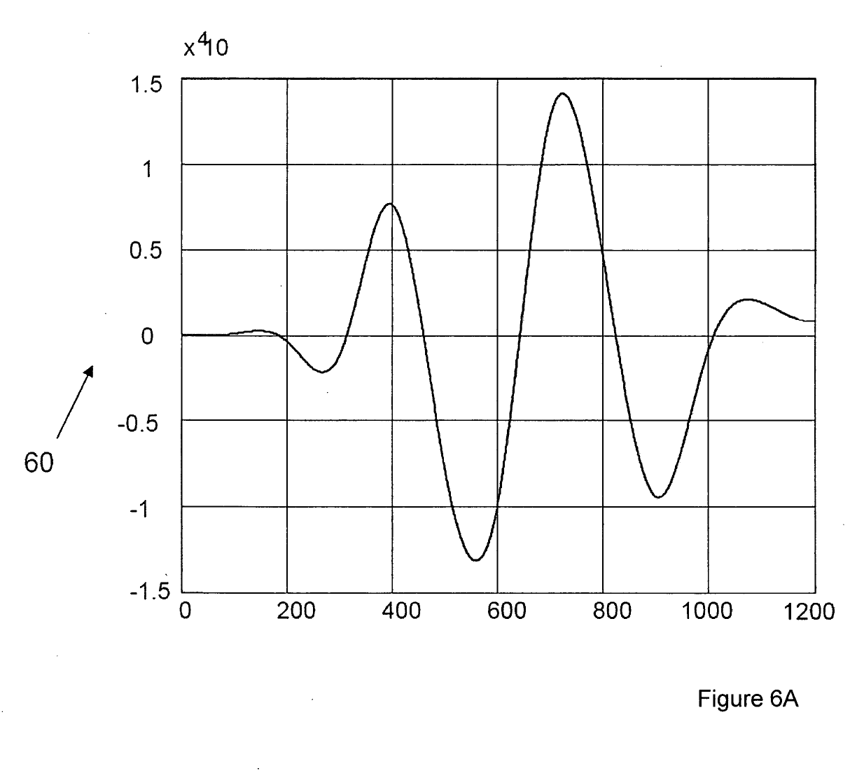

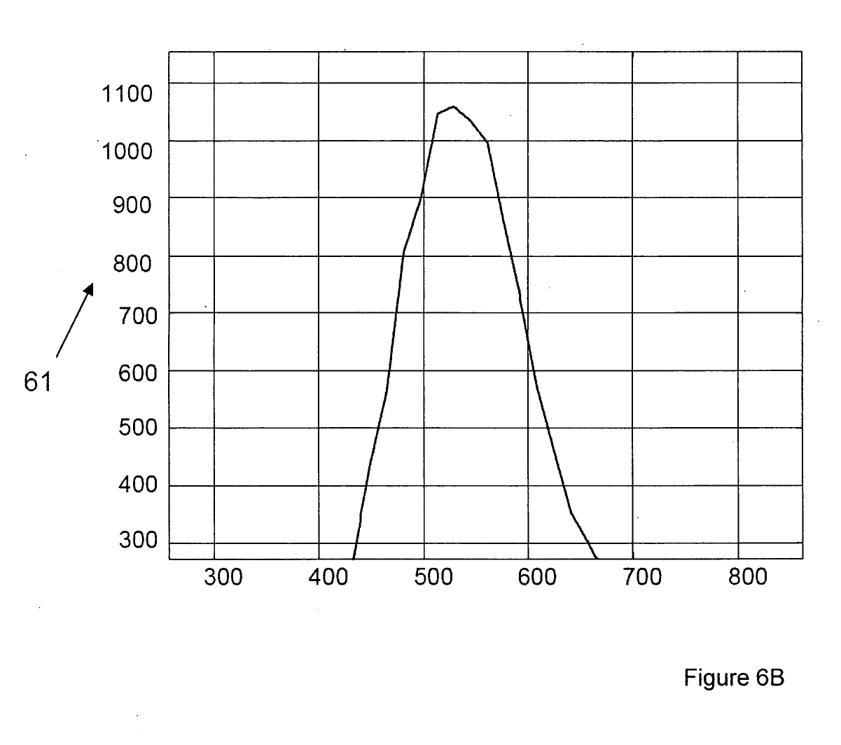

Assume that a radar time-domain pulse is received at the receiver input. An example of such known per se a signal (60) is depicted in FIG. 6A. Signal (60) is fed to an absolute module (51), that is followed by an LPF module (52) which smoothes the signal, and creates a signal (61) of the kind depicted in FIG. 6B.

Then the signal is compared (53) to a threshold, which detects a rising and a falling edge (the samples where the signals were crossing the threshold value). These edges are detected by a differential module (54) which e.g. performs XOR operation for any two consecutive samples. In accordance with certain embodiments, the threshold is high enough to overcome noise and small signals, and low enough to allow signal decrease (due to temperature/voltage effects). An exemplary threshold level can be 2-3 dB below the peak.

The rising edge sample shall be the “Early” indicator (55), and the falling edge shall be the “Late” indicator (60).

The presently disclosed subject matter is not bound by the specified envelope detection and a fortiori not by the specific circuitry and waveforms of FIGS. 5 and 6.

Having finalized the initial (calibration) phase and stored the internal delays and time of arrivals, there commences a real time phase in which the location of the object is determined.

As detailed with reference to FIG. 2, in operation (in real time determination of the object's location) it is required to determine the time of arrivals of the direct signals, and then determine the changes in time of arrivals (compared to those determined during the calibration stage) and based also on the initial internal delays, determine the sought real time internal delay.

As internal delays can vary over time (due to, e.g. variable temperature conditions), current (real time) internal delays should be calculated and taken into account when determining the real time object's location (in particular when high precision is required).

Reverting to the example of FIG. 3, suppose that there is a stored list of say 256 (initial) time-of arrival values for each of the 256 TX-RX direct links. Now, in real time the current time-of arrival values for each of the 256 TX-RX direct links are calculated for all polarities (using, e.g. the circuitry described with reference to FIG. 5).

In accordance with certain embodiments, the current time of arrival values of each direct link are compared respective stored values, giving rise to change in direct signals' time of arrivals.

More specifically, and as shown in FIG. 5, in accordance with certain embodiments, for each direct link both “Early” and “Late” values are compared to the respective stored “Early” and “Late” from the initial phase (56). The current Early is compared with the stored Early, and get the estimated “Early drift” (Early change). The same is performed to obtain the “Late drift” (Late Change). The total drift is the average of both drifts, giving rise to a single change value per direct link.

The presently disclosed subject matter is not bound by the use of only two comparison values (early and late) and obviously not by the average operator.

As already illustrated, in accordance with certain embodiments, the initial calibration phase extracts a specific delay for each direct link. This (initial) delay is subtracted from each operational link to get all the links to be lined up. This has been demonstrated schematically in equation (1) above, where for each operational link the corresponding D_{TX} and D_{RX} (initial) internal delays were neutralized.

The proposed description provides a relative coarse estimation of the delay change. For a more accurate estimation, instead of storing the Early and Late initial values, a portion of the original signal can be stored for each of the direct channels in the course of initial calibration. Then after allocating a coarse delay with the proposed E-L solution, a correlation estimator can be employed for better estimation of the exact delay.

Now, after having determined the change say Δ in time of arrival for a given direct link, the corresponding (real time) internal delay for this direct link can be determined. For instance: D_{TX} D_{Rx}+Δ. The latter equation may be regarded also as D_{Tx}′+D_{Rx}′=D_{Tx}+D_{Rx}+Δ. Note that D_{TX}′, D_{Rx}′ are the real time internal delays for the transmitter and receiver of this particular direct link. The real time internal delays can be provided separately (i.e. two distinct values D_{Tx}′, D_{Rx}′), or, in accordance with certain embodiments as a combined value, say D_{Tx}′+D_{Rx}′ for both the transmitter and receiver.

As in the initial phase, this (real time) delay is subtracted from each operational link to get all the links to be aligned. This has been demonstrated schematically in equation (2) above, where for each operational link the corresponding D_{Tx}′and D_{Rx}′ (real time) internal delays were neutralized.

In the specific case of having all 256 links, the change for each link can be calculated. But there may be some links whose direct links are blocked (especially for a planar system with dense receivers and transmitters). For these blocked links it is possible to calculate the delay change without observing the change in time of arrival of the specified blocked direct link. Actually it is possible to calculate the delay of these blocked links based on the change estimated in other links, as long as they share receivers and transmitters.

For example, assume that the real time delays for TX1-RX1 (link #1), TX2-RX1, (link #21), and TX2-RX16(link #36) are known (calculated). Now, the real time delay for TX1-RX16 (link #16) can be calculated from the known delays by a simple add/subtract computation:

Delay(link #1)=Delay(TX1)+Delay(RX1);

Delay(link #21)=Delay(TX2)+Delay(RX1);

Delay(link #36)=Delay(TX2)+Delay(RX16);

Delay(link #17)=Delay(channel 1)-Delay(channel 21)+Delay(channel 37).

Note that by this embodiment the combined delay of the transmitter and receiver per link (e.g. link #17) were calculated rather than the distinct values for the transmitter and the receiver separately.

Note also that only 32 links (rather than 256) are required to get the entire 32 delays (for the 16 receivers and 16 transmitters). However, due to estimation errors the redundancy in number of channels is utilized.

For example, by observing the remaining equations, it is possible to determine measurement errors (e.g. due to wrong placement of the plate). Averaging these errors, an error value for the plate positioning is obtained. Assuming for example that the receiver R16 “participates” in four equations (describing four links each in respect of a different one of the existing four transmitters), it may well be the case that the “delay” calculated for R16 is different for each one of four links. A non-limiting manner for compensating for these errors would be to average the four results in order to obtain the calculated delay for R16.

In accordance with certain embodiments, the number of RF links is determined such that each one of the RF units forms part of at least one link. For example, in the case of 32 units, there will be at least 32 links. In accordance with a certain embodiment, the number of links are selected from a maximum number of available communication links (by the latter example 256), according to selection criterion, e.g. according to quality of received signal.

Referring to FIG. 7, there is illustrated a generalized flow-chart of calibration of the system in case of obstacle-influenced internal delays.

When the system is placed against a wall or other obstacle, the antenna pattern can be changed, as the electromagnetic properties of the antenna depend on the permeability of its close proximity surroundings. Proximity of an obstacle is referred to hereinafter as a substantial proximity, if such an obstacle has influence on the electromagnetic properties of the RF units and/or combination thereof. Accordingly, internal delays can vary resulting from the substantial proximity of an obstacle, and the calibration provided in a free-space environment (or, optionally, in substantial proximity of previous obstacles) needs to be corrected.

Initial internal delays (71) of the transmitters and receivers and corresponding initial time of arrival(s) in direct links (72) are provided and stored for further use in a manner detailed with reference to FIGS. 2-5.

The method further includes measuring (72) obstacle-influenced time(s) of arrival(s) characterizing the direct link(s) and storing for further use.

Upon start of the operation, real time of arrivals in the direct links and the operational links are obtained (73), wherein each operational signal and respective direct signal(s) are constituted by different lobe components of a same signal.

Calculating (74) real time cumulative internal delays is provided based on real time of arrival in direct link(s), measured obstacle-influenced time of arrival and initial internal delays of RF units corresponding to the respective link(s). Real time location of the object is further determined (75) based on the operational signal time of arrival(s) and the real time cumulative relative internal delays of the operational links.

If the system has been calibrated and is stable with regard to the obstacle (and, optionally, all the channels have been aligned), signal calibration can be maintained by applying the following scheme:

The latest delay shift estimation together with the initial delay can be regarded as the current real time travel time of the signal in the space Dₛₚ′. Now a set of measurements takes place where each direct signal previously stored is replaced with a new measured obstacle-influenced signal. Any change in direct signals henceforth will be referenced to these stored signals and the additional delay will be added or subtracted from Dₛₚ′.

It will also be understood that the system according to the presently disclosed subject matter may be a suitably programmed computer. Likewise, the presently disclosed subject matter contemplates a computer program being readable by a computer for executing the method of the presently disclosed subject matter. The presently disclosed subject matter further contemplates a machine-readable memory tangibly embodying a program of instructions executable by the machine for executing the method of the presently disclosed subject matter.

The presently disclosed subject matter has been described with a certain degree of particularity, but those versed in the art will readily appreciate that various alterations and modifications may be carried out, without departing from the scope of the following Claims:

1. In a system comprising a plurality of RF units, said plurality comprising at least two transmitter and at least two receivers, a method of determining real time location of a reflecting object with the help of a plurality of operational signals, each operational signal transmitted by a certain transmitter towards the object and received by a corresponding receiver upon reflecting from the object, to yield a plurality of operational links between respective RF units, the method comprising:
(a) providing initial internal delays of said RF units, and providing initial direct signal time of arrivals characterizing direct links between RF units corresponding to said operational links;
(b) transmitting operational signals, and measuring real time of arrivals characterizing operational links;
(c) transmitting direct signals via direct links corresponding to said operational links, and measuring real time direct signal time of arrivals characterizing said direct links;
(d) calculating, separately for each of the operational links, cumulative real time internal delays in RF units, said calculating based on measured real time direct signal time of arrival in corresponding direct link, respective initial direct signal time of arrival and initial internal delays of respective RF units;
(e) calculating relative delays between the operational links and aligning the respective links; and
(f) determining the real time location of the object,
wherein operational signal and corresponding direct signal are constituted by different lobe components of a same signal transmitted between respective RF units.

2. The method of claim 1 wherein the internal delays of the RF unit are changed in response to change in at least one of the following:
(a) ambient temperature,
(b) voltage supplied to the R F unit;
(c) proximity of an obstacle.

3. The method of claim 1 wherein the real time location of the reflection object is determined with the help of operational signals measured for at least two co-polar operation links with different polarization and at least one cross-polar operational link, thereby enabling determining three-dimensional location of said object.

4. The method of claim 3 wherein the co-polar operational links comprise at least one link between a horizontally polarized transmitter and a horizontally polarized receiver and at least one link between a vertically polarized transmitter and a vertically polarized receiver, and wherein cross-polar operational links comprise at least one link between the vertically polarized transmitter and the horizontally polarized receiver or between the horizontally polarized transmitter and the vertically polarized receiver.

5. The method of claim 3 wherein the initial internal delays of said RF units comprise initial internal delays of receivers operable in co-polar links and initial internal delays of the same receivers operable in cross-polar links.

6. The method of claim 1 wherein at least part of RF units is located in a substantial proximity from an obstacle, the method further comprising measuring obstacle-influenced time of arrivals in the corresponding direct links, and calculating said cumulative real time internal delays in RF units based on the measured obstacle-influenced time of arrivals in direct links instead of initial direct signal time of arrival in the respective direct links.

7. An RF system comprising a plurality of RF units and a computer system with a data storage unit operatively coupled to the RF units, said plurality of RF units comprising at least two transmitters and at least two receivers, the system operable to determine real time location of a reflecting object with the help of a plurality of operational signals, each operational signal transmitted by a certain transmitter towards the object and received by a corresponding receiver upon reflecting from the object, to yield a plurality of operational links between respective RF units, wherein the computer system is operable:
to provide initial internal delays of said RF units;
to provide initial and real time direct signal time of arrivals characterizing direct links between RF units corresponding to said operational links;
to calculate, separately for each of the operational links, cumulative real time internal delays in RF units, said calculating based on measured real time direct signal time of arrival in corresponding direct link, respective initial direct signal time of arrival and initial internal delays of respective RF units; and
to calculate relative delays between the operational links and aligning the respective links; thereby to enable determining the real time location of the object,
wherein operational signal and corresponding direct signal are constituted by different lobe components of a same signal transmitted between respective RF units.

8. The system of claim 7 wherein the internal delays of the RF unit are changed in response to change in at least one of the following:
(a) ambient temperature
(b) voltage supplied to the RF unit
(c) proximity of an obstacle.

9. The system of claim 7 wherein the plurality of RF units comprises at least two transmitters with different polarization and at least two receivers with different polarization, and wherein the real time location of the reflection object is determined with the help of operational signals measured for at least two co-polar operation links with different polarization and at least one cross-polar operational link, thereby enabling determining three-dimensional location of said object.

10. The system of claim 9 wherein the co-polar operational links comprise at least one link between the horizontally polarized transmitter and the horizontally polarized receiver and at least one link between the vertically polarized transmitter and the vertically polarized receiver, and wherein cross-polar operational links comprise at least one link between the vertically polarized transmitter and the horizontally polarized receiver or between the horizontally polarized transmitter and the vertically polarized receiver.

11. The system of claim 9 wherein the initial internal delays of said RF units comprise initial internal delays of receivers operable in co-polar links and initial internal delays of the same receivers operable in cross-polar links.

12. The system of claim 9 wherein at least part of RF units is located in a substantial proximity from an obstacle, and wherein the computer system is further operable to provide obstacle-influenced time of arrivals in the corresponding direct links, and to calculate said cumulative real time internal delays in RF units based on the measured obstacle-influenced time of arrivals in direct links instead of initial direct signal time of arrival in the respective direct links.

13. In a system comprising a plurality of RF units, said plurality comprising at least two transmitters and at least two receivers, a program storage device readable by machine, tangibly embodying a program of instructions executable by the machine to perform a method of determining real time location of a reflecting object with the help of a plurality of operational signals, each operational signal transmitted by a certain transmitter towards the object and received by a corresponding receiver upon reflecting from the object, to yield a plurality of operational links between respective RF units, the method comprising:
(a) providing initial internal delays of said RF units, and providing initial direct signal time of arrivals characterizing direct links between RF units corresponding to said operational links;
(b) transmitting operational signals, and measuring real time of arrivals characterizing operational links;
(c) transmitting direct signals via direct links corresponding to said operational links, and measuring real time direct signal time of arrivals characterizing said direct links;
(d) calculating, separately for each of the operational links, cumulative real time internal delays in RF units, said calculating based on measured real time direct signal time of arrival in corresponding direct link, respective initial direct signal time of arrival and initial internal delays of respective RF units;
(e) calculating relative delays between the operational links and aligning the respective links; and
(f) determining the real time location of the object,
wherein operational signal and corresponding direct signal are constituted by different lobe components of a same signal transmitted between respective RF units.

14. In a system comprising a plurality of RF units, said plurality comprising at least two transmitters and at least two receivers, a computer program product comprising a computer useable medium having computer readable program code embodied therein for determining real time location of a reflecting object with the help of a plurality of operational signals, each operational signal transmitted by a certain transmitter towards the object and received by a corresponding receiver upon reflecting from the object, to yield a plurality of operational links between respective RF units, the computer program product comprising:
(a) computer readable program code for causing the computer to provide initial internal delays of said RF units, and providing initial direct signal time of arrivals characterizing direct links between RF units corresponding to said operational links;
(b) computer readable program code for causing the computer to transmit operational signals, and measuring real time of arrivals characterizing operational links;
(c) computer readable program code for causing the computer to transmit direct signals via direct links corresponding to said operational links, and measuring real time direct signal time of arrivals characterizing said direct links;
(d) computer readable program code for causing the computer to calculate, separately for each of the operational links, cumulative real time internal delays in RF units, said calculating based on measured real time direct signal time of arrival in corresponding direct link, respective initial direct signal time of arrival and initial internal delays of respective RF units;
(e) computer readable program code for causing the computer to calculate relative delays between the operational links and aligning the respective links; and
(f) computer readable program code for causing the computer to determine the real time location of the object,
wherein operational signal and corresponding direct signal are constituted by different lobe components of a same signal transmitted between respective RF units.
